(19) United States
(12) Patent Application Publication
(10) Pub. No.: US 2021/0374068 A1
(43) Pub. Date: Dec. 2, 2021

(54) Address Fine-Tuning Acceleration System

(71) Applicant: Huaxia General Processor Technologies Inc., Beijing (CN)

(72) Inventors: Xiaolong FEI, Beijing (CN); Lei WANG, Beijing (CN); Ting YANG, Beijing (CN)

(73) Assignee: Huaxia General Processor Technologies Inc., Beijing (CN)

(21) Appl. No.: 16/887,817

(22) Filed: May 29, 2020

(51) Int. Cl. G06F 12/10

(52) U.S. Cl. CPC G06F 12/10; G06F 2212/657

(57) ABSTRACT

An address fine-tuning acceleration system in the technical field of address fine-tuning is disclosed. The system includes a scheduling unit, a high-order physical register block, a shared mapping unit, an address checking unit, a low-order physical register block, an immediate value detection unit, a physical memory address fine-tuning detector, a new address generation unit, a reservation station, an execution and virtual-physical memory address conversion unit, and a submission unit.

### TECHNICAL FIELD

The present disclosure relates to the technical field of address fine-tuning, and more particularly, to an address fine-tuning acceleration system.

### BACKGROUND

At present, address calculation information is embedded in a memory access instruction of a main instruction stream. Responsive to receiving the instruction, the memory access circuit may calculate a virtual memory address using an internal Address Generation Unit (AGU), and then store the virtual memory address into a cache and Translation Look-aside Buffer (TLB) to complete the preparation of memory access using the Virtual Indexed Physical Tagged (VIPT). Therefore, the mapping between a virtual memory address and a physical memory address are always concatenated after the memory address generated by the AGU, and the address conversion is performed when address memory access is needed. Instruction Set Architecture (ISA) determines the timing of the conversion between the virtual memory addresses and physical memory addresses of the memory access instruction. If memory access address calculation is extracted separately to become an independent instruction and a special architected register is defined, another memory access style is formed: Data Translation Look-aside Buffer (DTLB) access is completed during each address calculation, a physical memory address and attributes are obtained and stored with the virtual memory address to the architected register, and the memory access instruction obtains the physical memory address and page information by reading the address register each time. In the latter, if a compiler schedules reasonably, address calculation and delay in a mapping process can be overlapped with other instructions, so as to ensure that the physical memory address and the page information are directly read out when the memory access instruction arrives, and the cache is accessed. However, the deficiency of this approach is that the pipeline length of an instruction is increased due to the need of accessing DTLB during each address calculation. The present disclosure is intended to accelerate an address adjustment instruction, thereby reducing the pipeline length.

### SUMMARY

The present disclosure is to provide an address fine-tuning acceleration system to solve the above-specified technical problem that the pipeline length of an instruction is increased due to the need of accessing DTLB during each address calculation. Implementations of the present disclosure accelerate an address adjustment instruction, thereby reducing the pipeline length.

To this end, the present disclosure provides the following technical solutions. An address fine-tuning acceleration system includes: a scheduling unit, a high-order physical register block, a shared mapping unit, an address checking unit, a low-order physical register block, an immediate value detection unit, a physical memory address fine-tuning detector, a new address generation unit, a reservation station, an execution and virtual-physical memory address conversion unit, and a submission unit. An output end of the scheduling unit is connected to an input end of the address checking unit, an input end of the immediate value detection unit and an input end of the low-order physical register block through wires. An output end of the address checking unit is connected to an input end of the reservation station, an input end of the physical memory address fine-tuning detector and the input end of the low-order physical register block through wires. An output end of the high-order physical register block is connected to an input end of the shared mapping unit through a wire. An output end of the shared mapping unit is connected to an input end of a high-order physical register block through a wire. An output end of a low-order physical register block is connected to an input end of the new address generation unit and the input end of the physical memory address fine-tuning detector through wires. An output end of the immediate value detection unit is connected to the input end of the new address generation unit and the input end of the physical memory address fine-tuning detector through wires. An output end of the physical memory address fine-tuning detector is connected to an input end of the submission unit through a wire. An output end of the reservation station is connected to an input end of the execution and virtual-physical memory address conversion unit, the input end of the new address generation unit and the input end of the shared mapping unit through wires. An output end of the new address generation unit is connected to the input end of the low-order physical register block, the input end of the shared mapping unit and an input end of the reservation station through wires. An output end of the execution and virtual-physical memory address conversion unit is connected to the input end of the low-order physical register block, an input end of the high-order physical register block and the input end of the submission unit through wires.

Optionally, the execution and virtual-physical memory address conversion unit is to communicate with the low-order physical register block through a result and a spread bit.

Optionally, the address checking unit is to communicate with the reservation station through address generation type pushing.

Optionally, the low-order physical register block is to communicate with the physical memory address fine-tuning detector through a spread bit.

Optionally, the reservation station is to communicate with the new address generation unit and the shared mapping unit through new address write enabling.

Optionally, the address fine-tuning acceleration system further includes a standby address unit, and the new address generation unit is to communicate with the standby address unit through address tuning type spread pushing.

Optionally, a physical memory address is communicatively connected to the submission unit through a new submission path.

Optionally, the new address generation unit is to communicate with the low-order physical register block by maintaining a high-order change bit.

Optionally, the execution and virtual-physical memory address conversion unit is to communicate with the low-order physical register block by clearing a spread bit.

Compared with the existing technology, the present disclosure has the following beneficial effects. According to the present disclosure, an execution speed of an address fine-tuning instruction can be increased, the dynamic power consumption of overall address conversion can be reduced. If a certain instruction does not satisfy an optimization condition, a previous execution path can be kept unchanged, and performance reduction can be avoided. Moreover, a single-key switching on/off can be realized. For an address register, dual physical register blocks are used to distinguish between high and low orders, and multiple low-order addresses are mapped to the same high-order physical register, having the further benefits of simplifying the update of the physical register by an address fine-tuning instruction, reducing the overhead area, the address fine-tuning instructions sharing a mapping relationship and attributes of an address generation instruction, saving the bandwidth of a reservation station, reducing the power consumption of DTLB access, reducing the pipeline length, simplifying the spread judgment using a spread bit, and avoiding inconsistent errors caused by updating DTLB by quickly setting the bit. Multiple levels of configuration accomplish the design of different complexities, including: configuring a risk range and choosing whether to open a separate write-back channel.

### BRIEF DESCRIPTION OF THE DRAWINGS

FIG. 1 is a schematic block diagram of a system according to the present disclosure.

### DETAILED DESCRIPTION OF THE EMBODIMENTS

The technical solutions in the embodiments of the present disclosure will be clearly and completely described hereinbelow with the drawings in the embodiments of the present disclosure. It is apparent that the described embodiments are only part of the embodiments of the present disclosure, not all of the embodiments. On the basis of the embodiments of the present disclosure, all other embodiments obtained on the premise of no creative work of those of ordinary skill in the art fall within the scope of protection of the present disclosure.

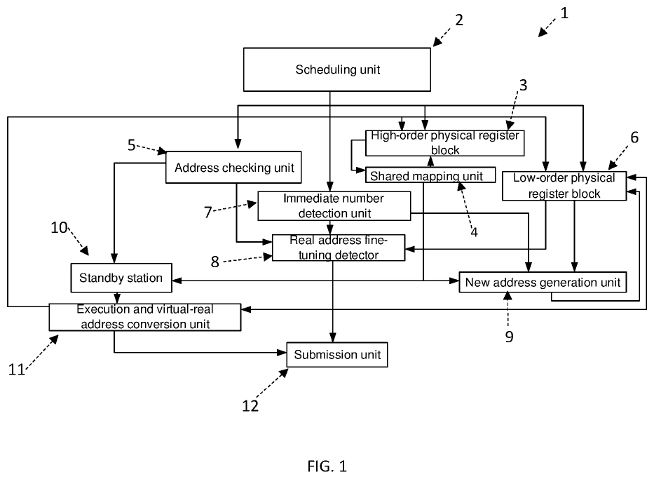

The present disclosure provides an address fine-tuning acceleration system. According to embodiments of the present disclosure, an execution speed of an address fine-tuning instruction can be increased, and the dynamic power consumption of overall address conversion can be reduced. If a certain instruction does not satisfy an optimization condition, a previous execution path can be kept unchanged, and performance reduction can be avoided. Moreover, one-key switching can be realized. Referring to FIG. 1, the address fine-tuning acceleration system 1 includes: a scheduling unit 2, a high-order physical register block 3, a shared mapping unit 4, an address checking unit 5, a low-order physical register block 6, an immediate value detection unit 7, a physical memory address fine-tuning detector 8, a new address generation unit 9, a reservation station 10, an execution and virtual-physical memory address conversion unit 11, and a submission unit 12. An output end of the scheduling unit 2 is connected to an input end of the address checking unit 5, an input end of the immediate value detection unit 7 and an input end of the low-order physical register block 6 through wires. An output end of the address checking unit 5 is connected to an input end of the reservation station 10, an input end of the physical memory address fine-tuning detector 8 and the input end of the low-order physical register block 6 through wires. An output end of the high-order physical register block 3 is connected to an input end of the shared mapping unit 4 through a wire. An output end of the shared mapping unit 4 is connected to an input end of a high-order physical register block 3 through a wire. An output end of a low-order physical register block 6 is connected to an input end of the new address generation unit 9 and the input end of the physical memory address fine-tuning detector 8 through wires. An output end of the immediate value detection unit 7 is connected to the input end of the new address generation unit 9 and the input end of the physical memory address fine-tuning detector 8 through wires. An output end of the physical memory address fine-tuning detector 8 is connected to an input end of the submission unit 12 through a wire. An output end of the reservation station 10 is connected to an input end of the execution and virtual-physical memory address conversion unit 11, the input end of the new address generation unit 9 and the input end of the shared mapping unit 4 through wires. An output end of the new address generation unit 9 is connected to the input end of the low-order physical register block 6, the input end of the shared mapping unit 4 and an input end of the reservation station 10 through wires. An output end of the execution and virtual-physical memory address conversion unit 8 is connected to the input end of the low-order physical register block 6, an input end of the high-order physical register block 3 and the input end of the submission unit 12 through wires.

### Embodiment 1

Each time an address generation instruction is written back, it is checked concurrently whether the address is within a certain range that is not possible spread between two pages. Two bits are respectively used to indicate whether it will spread between two pages with an adjacent front page and an adjacent back page. The range selection can be adjusted according to the frequency value specified by a fine-tuning immediate value if there is no bit setting corresponding to a spread risk. Each time an address fine-tuning instruction reads a base address from a register block, if the immediate value is less than a safety distance, and the address conversion of a base address register is completed a conversion result is directly read and assigned to its own address register. At this moment, a low-order address and immediate value read by the register block are selected for operation, and a result is written back to the low-order address portion of the address register. Another optional optimization mode is to separate the high order, page attributes and low order of the address register into two physical register arrays. The high order and page attributes belong to one physical register block, and the low order belongs to the other physical register block. Each time an address fine-tuning instruction satisfies conditions, it is not necessary to allocate a new high-order physical register and an original base physical register is directly mapped to a current new address register. Therefore, the number of high-order physical registers in register resources should be fewer than the number of low-order physical registers. As a cost, the logic of front-end resource detection needs to be more detailed. But it provides further area savings because only address fine-tuning instructions and address generation instructions with spread risks require new storage to record the attributes of huge pages. Because is not a high probability event, separation makes the design of a micro-system easier to scale up. Because multiple physical registers are introduced to reflect the same architected register, it is necessary to consider whether there is a problem of multi-mapping when recycling, and the high-order physical registers of multi-mapping cannot be recycled.

### Embodiment 2

The creation of a separate submission channel for an acceleration fine-tuning instruction allows for an instruction retire unit to quickly detect the completion of this instruction, so that the requirements of shortening instruction pipeline are completed. Similarly, a separate write-back channel may also be opened, and a result is given to a memory access module. If a separate write-back channel is created, such instructions do not need to be pushed into a reservation station, the instructions are completed in advance at the previous level, and the transmission bandwidth and capacity of the reservation station are saved. If the complexity of the additional write-back channel to the memory access module (more logic for address correlation detection) is considered, such acceleration instruction may also be pushed into the reservation station, normal execution and address conversion are performed, and the instruction is sent to a write-back path of the memory access module before reused. The only difference is that the result of the normal path address conversion does not need to be written back to the register block (the previous fast path has updated the register block). The benefit obtained is that the pipeline of the instruction is shortened, which can be retired in advance, and other logic remains unchanged, and other resource consumptions are minimized. If the fine-tuning instruction does not need to be sent to the memory access module by an additional write-back path and does not need to be pushed into the reservation station when the physical register is updated cyclically, because memory access instructions behind the next cycle may read new physical register content, and if there are address-related memory access instructions and address fine-tuning instructions in the same cycle, the instruction still needs to be pushed into the reservation station because newest data cannot be obtained in time.

### Embodiment 3

A separate submission and write-back path is created. For a sequence of sequential fine-tuning and continuous memory access, the effect is that only the initial address generation instruction requires general calculation and access to DTLB, and all subsequent accesses without spread risks are not required to access DTLB again, so that the pipeline power consumption is greatly saved, and the ultimate power consumption ratio optimization is achieved. It is to be noted here that if a compiler guarantees that each time the mapping or page attributes of virtual and physical memory addresses is changed, when accessing an address in the page where the mapping is changed, there is an address generation instruction in advance to update mapping or page attributes, and it is not necessary to perform any special processing. The address fine-tuning instruction may use the same page of mapping information and attributes securely each time. But if it is not guaranteed, it means that if the mapping and attributes of an outdated page are used without authorization, it is necessary to zero-clear two spread risk bits of a low-order physical register of a corresponding page each time a program updates the page (0 means that there is a spread risk, 1 means that there is no spread risk. It is initialized to 0 when powering on, and if it is inconvenient to select related pages, they may all be zero-cleared), and then a newly-introduced fine-tuning instruction of this page will recalculate a virtual memory address normally and access DTLB once to obtain the latest page mapping and attributes, and regenerate a spread risk bit according to the virtual memory address.

Based on the foregoing, according to the present disclosure, an execution speed of an address fine-tuning instruction can be increased, the dynamic power consumption of overall address conversion can be reduced. If a certain instruction does not satisfy an optimization condition, a previous execution path can be kept unchanged, and performance reduction can be avoided. Moreover, one-key switching on/off can be realized. For an address register, dual physical register blocks are used to distinguish between high and low orders, and multiple low-order addresses are mapped to the same high-order physical register, which further simplifies the update of the physical register of an address fine-tuning instruction and saves area overhead. The address fine-tuning instruction shares a mapping relationship and attributes of an address generation instruction, the bandwidth of a reservation station is saved, the power consumption of DTLB access is reduced, the pipeline length is reduced, a spread bit is used to make the spread judgment simple, inconsistent errors caused by updating DTLB are avoided by quickly setting the bit, and multiple levels of configuration complete the design of different complexity, including: configuring a risk range and choosing whether to open a write-back channel separately.

Although the embodiments of the present disclosure have been shown and described, those of ordinary skill in the art can understand that various changes, amendment, substitutions, and variations can be made to these embodiments without departing from the principle and spirit of the present disclosure, the scope of the present disclosure is defined by the appended claims and their equivalents.

What is claimed is:

1. An address fine-tuning acceleration system, comprising: a scheduling unit, a high-order physical register block, a shared mapping unit, an address checking unit, a low-order physical register block, an immediate value detection unit, a physical memory address fine-tuning detector, a new address generation unit, a reservation station, an execution and virtual-physical memory address conversion unit, and a submission unit, wherein an output end of the scheduling unit is coupled to an input end of the address checking unit, an input end of the immediate value detection unit and an input end of the low-order physical register block; an output end of the address checking unit is coupled to an input end of the reservation station, an input end of the physical memory address fine-tuning detector and the input end of the low-order physical register block; an output end of the high-order physical register block is coupled to an input end of the shared mapping unit through; an output end of the shared mapping unit is coupled to an input end of a high-order pulse; an output end of a low-order pulse is coupled to an input end of the new address generation unit and the input end of the physical memory address fine-tuning detector; an output end of the immediate value detection unit is coupled to the input end of the new address generation unit and the input end of the physical memory address fine-tuning detector; an output end of the physical memory address fine-tuning detector is coupled to an input end of the submission unit; an output end of the reservation station is coupled to an input end of the execution and virtual-physical memory address conversion unit, the input end of the new address generation unit and the input end of the shared mapping unit; an output end of the new address generation unit is coupled to the input end of the low-order physical register block, the input end of the shared mapping unit and an input end of the reservation station; and an output end of the execution and virtual-physical memory address conversion unit is coupled to the input end of the low-order physical register block, an input end of the high-order physical register block and the input end of the submission unit.

2. The address fine-tuning acceleration system according to claim 1, wherein the execution and virtual-physical memory address conversion unit is to communicate with the low-order physical register block through a result and a spread bit.

3. The address fine-tuning acceleration system according to claim 1, wherein the address checking unit is to communicate with the reservation station through address generation type pushing.

4. The address fine-tuning acceleration system according to claim 1, wherein the low-order physical register block is to communicate with the physical memory address fine-tuning detector through a spread bit.

5. The address fine-tuning acceleration system according to claim 1, wherein the reservation station is coupled to the new address generation unit and the shared mapping unit through new address write enabling.

6. The address fine-tuning acceleration system according to claim 1, wherein the address fine-tuning acceleration system further comprises a standby address unit, and the new address generation unit is coupled to the standby address unit through address tuning type spread pushing.

7. The address fine-tuning acceleration system according to claim 1, wherein a physical memory address is coupled to the submission unit through a new submission path.

8. The address fine-tuning acceleration system according to claim 1, wherein the new address generation unit is coupled to the low-order physical register block by maintaining a high-order change bit.

9. The address fine-tuning acceleration system according to claim 1, wherein the execution and virtual-physical memory address conversion unit is coupled to the low-order physical register block by clearing a spread bit.
